(19) United States
(12) Patent Application Publication
(10) Pub. No.: US 2007/0194560 A1
(43) Pub. Date: Aug. 23, 2007

(54) FOLDABLE CART

(76) Inventor: Timothy W. Zink, Wonder Lake, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/673,978

(22) Filed: Feb. 12, 2007

Related U.S. Application Data
(60) Provisional application No. 60/774,742, filed on Feb. 17, 2006.

(51) Int. Cl. B62B 1/00

(52) U.S. Cl. 280/652

(57) ABSTRACT

The invention provides a cart for transporting objects, such as game, that can be folded into a closed configuration for easy transportation and storage. In the open configuration, the cart is suitable for transporting heavy objects over difficult terrain. The cart has an angled frame such that it cradles the object retained thereon. The cart is designed such that an object can be easily loaded onto the cart. For example, the cart may be pivoted downward to minimize the distance that the object being loaded on the cart needs to be lifted, and the cart also has one or more rollers that allow the object to be slidably loaded and positioned on the cart. The cart may additionally have retaining straps to secure an object to the cart. Finally, the cart has forward wheels that allow the cart to be easily loaded into a vehicle.

### CROSS-REFERENCE TO RELATED APPLICATIONS

This patent application claims the benefit of U.S. Provisional Patent Application No. 60/774,742, filed Feb. 17, 2006, which is incorporated by reference in its entirety herein.

### FIELD OF THE INVENTION

The invention pertains to carts for transporting objects, and more specifically, to carts for transporting game.

### BACKGROUND OF THE INVENTION

Carts for transporting objects are known in the art. Many current carts are large and heavy, and thus, difficult to transport and store. They typically include one or more wheels disposed below a horizontal surface used to support the object. The horizontal surface is usually disposed a given distance above the ground such that the operator of the cart is required to lift the object that distance to load the object onto the cart. When the object is particularly heavy and/or awkward to lift, raising the object the necessary height to load onto the cart is difficult and, depending on the size of the object, often impossible for an individual to accomplish without assistance. Once an object is loaded onto the cart, current carts are often not suited for transportation over difficult terrain. Typically, the center of gravity of the cart and object combination is such that the operator must exert a significant amount of effort to prevent the cart from tipping, and usually the wheels are too small to easily navigate over uneven terrain. Finally, in order to place the object and/or cart into a vehicle, the object must either be unloaded from the cart and lifted into the vehicle (often the flatbed of a truck), or the object and cart combination must be loaded together into the vehicle. Either scenario is undesirable because the burden is placed on the operator(s) to lift the entire weight of the object, or object and cart to place them in the vehicle.

### BRIEF SUMMARY OF THE INVENTION

The invention provides a cart for transporting objects, such as game, that can be folded into a closed configuration for easy transportation and storage. In the open configuration, the cart has two large main wheels disposed generally near the lengthwise center of the cart, making the cart suitable for transporting heavy objects over difficult terrain. The cart has an angled frame such that it cradles the object retained thereon. The cart is designed such that an object can be easily loaded onto the cart. For example, the cart may be pivoted downward to minimize the distance that the object being loaded on the cart needs to be lifted. Additionally, the cart also has one or more rollers that allow the object to be slidably loaded and positioned on the cart. Thus, an operator need not undergo undue difficulties in loading heavy and/or awkward objects onto the cart. The cart may also have retaining straps to secure an object to the cart. To assist with loading the cart and retaining the cart in a stationary position, the cart may further have a braking mechanism and/or one or more support legs that can be pivoted downward from the frame of the cart.

The cart may have one or more smaller forward wheels used to load the cart into a vehicle. The angled frame and lengthwise centered main wheels permit the forward end of the cart to be pivoted upward to rest on the vehicle (such as the flatbed of a truck). The rearward end of the cart may then be pivoted upward, using the forward wheels as a pivot point. The forward wheels may then roll on the surface of the vehicle as the cart is pushed forward. Thus, an operator need not remove the object from the cart to load into a vehicle, nor does the operator need to lift the entire weight of the cart or object because the vehicle will support a portion of the weight. The cart may comprise suitable components such as accessory holders, leg spreaders, and/or ski assemblies.

### BRIEF DESCRIPTION OF THE DRAWINGS

FIG. 1 is a perspective view from above of a cart in accordance with teachings of the invention;

FIG. 2 is an elevational side view of the cart of FIG. 1;

FIG. 3 is a top plan view of the cart of FIG. 1;

FIG. 4 is a perspective view from above of the cart of FIG. 1 with retaining straps and a hitch attached;

FIG. 5 is a perspective view of the cart of FIG. 1 with the support arms lowered;

FIG. 6 is a fragmentary elevational side view of the cart of FIG. 1 with the brake disengaged;

FIG. 7 is a fragmentary elevational side view of the cart of FIG. 1 with the brake engaged;

FIG. 8 is a forward perspective view of the cart of FIG. 1;

FIG. 9 is a perspective view of the cart of FIG. 1 in a partially assembled open configuration;

FIG. 10 is a top plan view of the cart of FIG. 1 in a partially assembled open configuration;

FIG. 11 is a fragmentary perspective view of the cart of FIG. 1 in a closed configuration with one of the slide locks engaged;

FIG. 12 is a perspective view of the cart of FIG. 1 in a closed configuration;

FIG. 13 is another perspective view of the cart of FIG. 1 in a closed configuration;

FIG. 14 is another perspective view of the cart of FIG. 1 with several components coupled to the cart; and

FIG. 15 is a further perspective view of the cart of FIG. 1 with a ski assembly coupled to the cart.

### DETAILED DESCRIPTION OF THE INVENTION

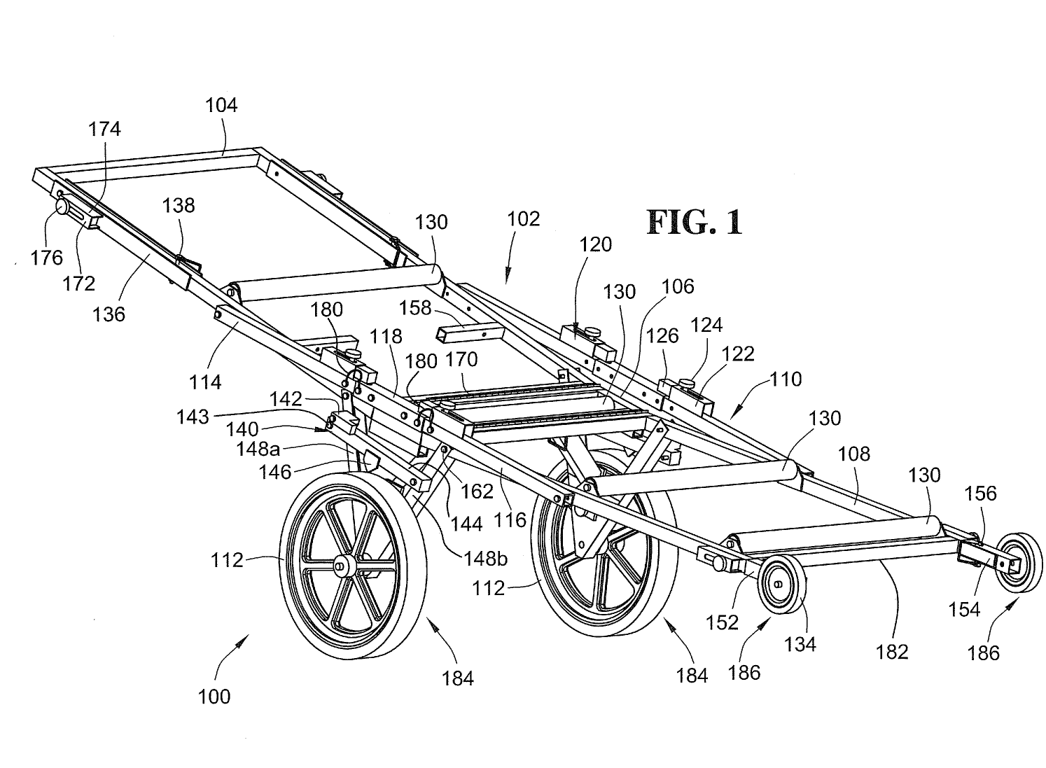

Turning to the drawings, there is shown in FIG. 1, a cart 100 for transporting objects, such as game. The cart 100 has a structure that eases the loading of objects onto the cart 100, transporting objects on the cart 100 from one location to another, loading the cart 100 into a vehicle, and removing objects from the cart 100. The cart 100 further has a structure that permits the cart 100 to be converted from a closed storage configuration to an open transportation configuration such that, in the closed storage configuration, the cart 100 is reduced in size sufficiently to be carried on an operator's back. Furthermore, the cart 100 in the closed storage configuration is significantly more compact than the cart 100 in the open transportation configuration such that the cart 100 can be stored in a relatively small space when not in use.

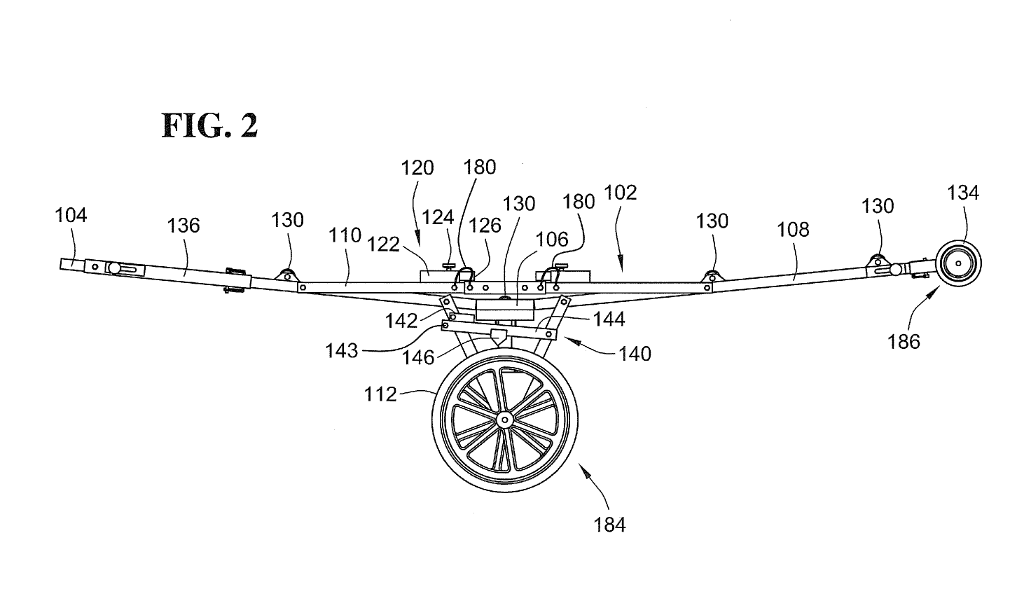

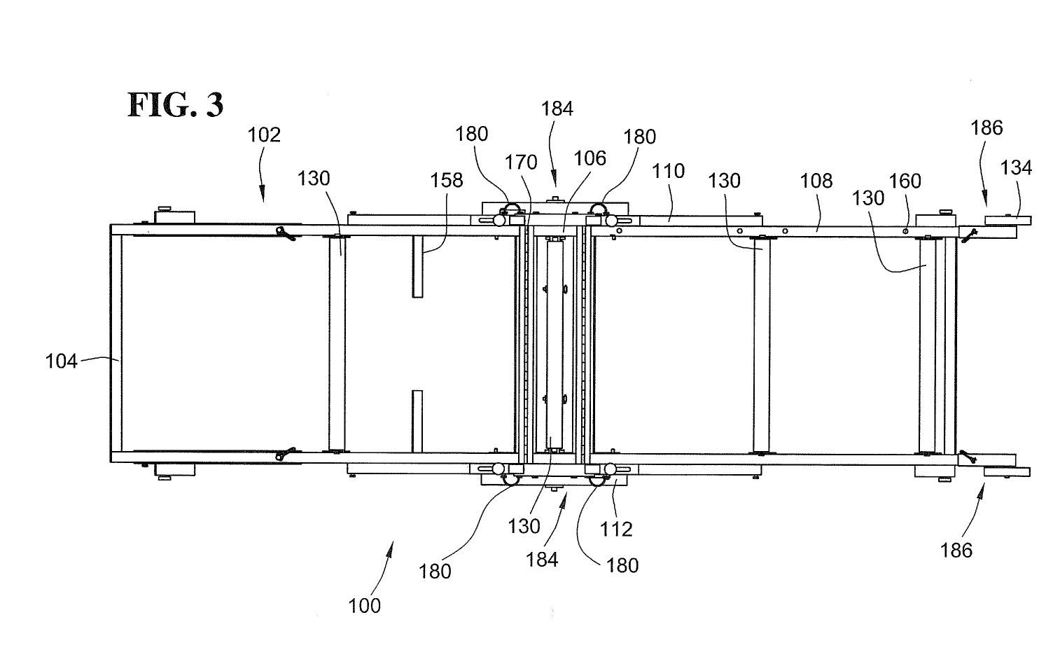

As shown in FIGS. 1-3, the cart 100 comprises a frame 102 that supports objects stored thereon. The frame 102 generally comprises a rear handle portion 104, a center transition portion 106, and a forward support portion 108. The frame 102 may further comprise support braces 110 connecting the rear handle portion 104 with the forward support portion 108. The cart 100 is generally supported by a pair main wheel assemblies 184 each comprising a main wheel 112 that may be disposed below the center transition portion 106 to support the mid-section of the cart 100. The main wheels 100 may have a relatively large outer diameter such that they permit the cart to easily navigate over difficult terrain. The main wheels 112 may also support the frame 102 above the ground a sufficient height to permit a user to push or pull the cart 100 from a standing position rather than forcing the operator of the cart 100 to uncomfortably reach downward in order to push or pull the cart 100. The main wheels 112 may have any suitable outer diameter such that the cart 100 may easily navigate over difficult terrain and such that the main wheels 112 support the frame a desired distance above the ground. In some embodiments, the main wheels 112 may have an outer diameter that is approximately greater than or equal to ten inches and approximately less than or equal to sixteen inches. The outer diameter of the main wheels 112 in some such embodiments may be on the order of 13.5 inches.

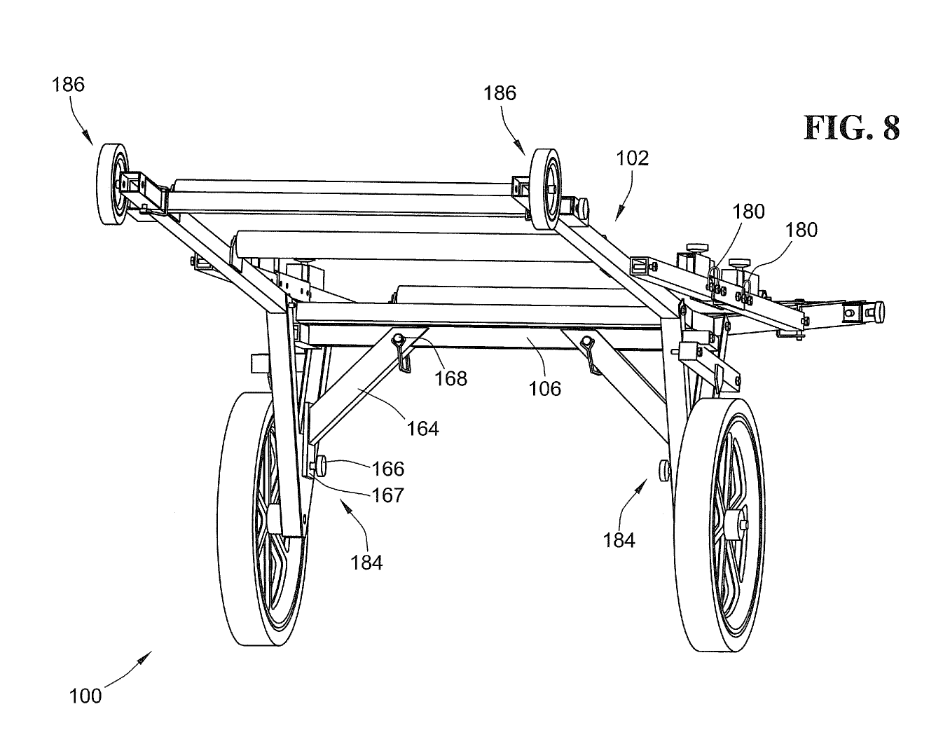

Each of the main wheels 112 is connected to the frame 102 via a pair of support members 148a, 148b that may be part of the main wheel assembly 184 and may be disposed as an inverted A-frame support structure. As shown in FIG. 8, the main wheel assemblies 184 may comprise angled support bars 164 which may be provided to support the support members 148a, 148b. In the illustrated embodiment, the angled support bars 164 are detachably coupled to the center transition portion 106 and the support members 148a, 148b by pins 168 and threaded rods 167, respectively, or other appropriate structure. The threaded rod 167 may be manipulated by knob 166 or other structure.

As shown, the rear handle portion 104 and the forward support portion 108 are angled relative to one another to serve as a cradle for retaining objects. The rear handle portion 104 and the forward support portion 108 may be disposed at any suitable angle relative to one another. To support and maintain the angled configuration of the open cart 100, the two support braces 110 are disposed on respective sides of the cart 100. The support braces 110 may also restrict lateral movement of an object retained on the cart 100.

Each of the support braces 110 comprises a rear member 114 for attachment to the rear handle portion 104 of the frame 102, a forward member 116 for attachment to the forward support portion 108 of the frame 102, and an intermediate member 118 connecting the aforementioned members to one another. Each of the rear and forward members 114, 116 have a locking mechanism 120 disposed thereon. The locking mechanism 120 comprises a housing 122, a sliding knob 124, and a bar 126. The sliding knobs 124 may be used to move the bars 126 in and out of the housings 122. When the bars 126 are extended, they retain the forward member 116, the rear member 114, and the intermediate member 118 in a substantially co-linear orientation relative to one another to support the frame portions 104, 106, 108 of the cart 100 and restrict lateral movement of objects on the cart 100 as discussed above. The intermediate member 118 may also have locking apertures 128 for securing the cart 100 in a closed position as explained in further detail below.

The cart 100 has one or more features that assist an operator to load and unload an object onto the frame 102 of the cart 100. Frequently, an operator will need to load a relatively heavy and/or awkward object onto the cart 100. For example, a deer carcass may weigh several hundred pounds and have a length of six feet or larger. Typically, an object of this size can be extremely difficult to load without the assistance of several individuals to lift and place the object onto the cart 100. In accordance with teachings of the invention, the cart may have one or more rollers 130 disposed on the frame 102 to permit an object to be slidably loaded onto the cart 100. It will be appreciated that any number of rollers 130 may be utilized and the rollers 130 may be disposed at any suitable location on the cart 100.

As shown in FIG. 1, in the illustrated embodiment of the invention, a roller 130 may be disposed near the rear handle portion 104, a roller 130 may be disposed near the center transition portion 106, and two rollers 130 may be disposed near the forward support portion 108. As shown, one or more of the rollers 130 may be attached directly to a portion of the frame 102 via an aperture drilled in the tubing of the frame 102 (e.g., the roller 130 disposed near the center transition portion 106). Alternately, one or more of the rollers 130 may be coupled to the frame 102 via a bracket or other suitable structure (e.g., the roller 130 disposed near the rear handle portion 104). As an object is loaded near the forward support portion 108, the object is placed on one or more of the rollers 130 near the forward support portion 108. The object may then be pushed and/or pulled to slide the object further onto the cart 100, as opposed to requiring the operator to lift the object in its entirety to maneuver the object onto the cart 100. The rollers 130 similarly aid in slidably removing an object from the cart 100. Thus, the rollers 130 permit an operator of the cart 100 to relatively easily load and unload an object from the cart 100. The rollers 130 may be disposed in any suitable orientation or manner on the cart 100 to aid in the maneuvering of an object disposed on the cart 100, including but not limited to, the maneuvering of an object onto and off of the cart 100.

In some embodiments, the cart 100 may have one or more crossbar supports 182 disposed across the frame 102, such as shown in FIG. 1. The crossbar supports 182 provide support for an object placed on the cart 100. In some embodiments, the cart 100 may comprise a netting, canvas, mesh, or other suitable structure attached to the frame 102 to support an object placed thereon. A netting, canvas, mesh, or other suitable structure may be used to transport relatively small objects and/or prevent objects from falling through the frame 102 of the cart. Although not illustrated in the figures, it will be appreciated that such netting, canvas, mesh, or other suitable structure may be disposed over all or only a portion of the frame 102 and may be coupled thereto, if desired, in any appropriate manner. The netting, canvas, mesh, or other suitable structure may likewise include a portion adapted to be disposed over a carcass or other object supported on the cart 100.

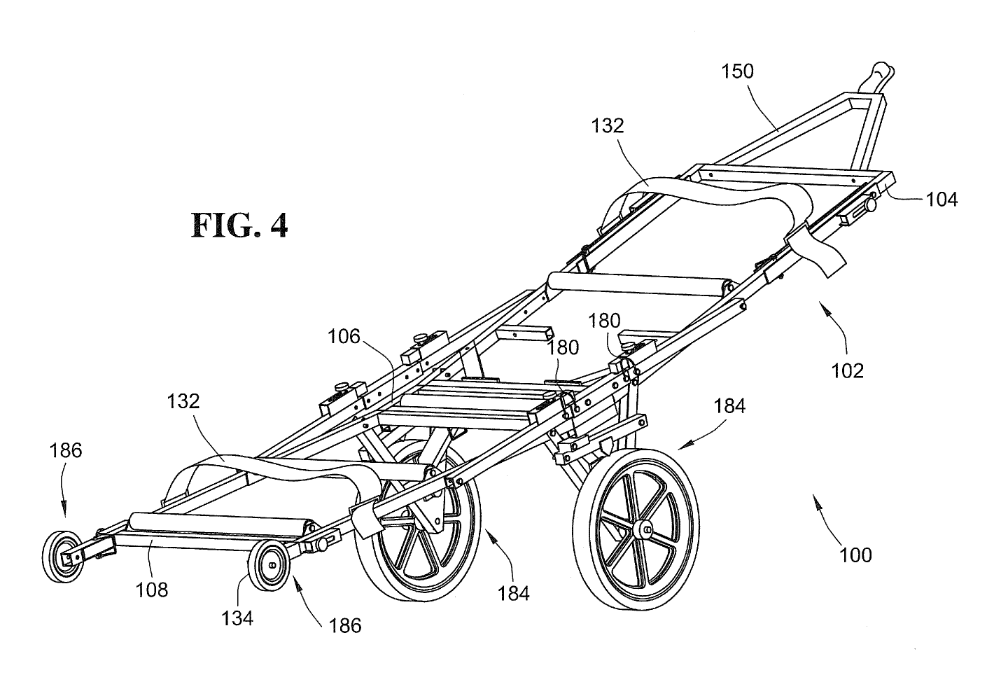

In order to prevent the object from undesirably sliding off of the cart 100, the cart 100 may have one or more retaining features for securing an object to the cart 100 after an operator has maneuvered the object thereon. For example, turning to FIG. 4, the cart 100 may have one or more retaining straps 132 that may be disposed over the object and tightened to hold the object against the cart 100. In this way, an object loaded on the cart 100 may be secured to prevent the object from sliding off of the cart 100 when the cart 100 is resting on its main wheels 112 and forward wheels 134 or when the cart 100 is navigated over difficult terrain. It will be appreciated that the cart 100 may have any suitable number of retaining straps 132 disposed at any suitable location on the cart 100. It will also be appreciated that the retaining straps 132 may or may not be fixed to the frame (i.e., they may be removably disposed) and may comprise one or more ratchet devices suitable for tightening the retaining straps 132. Further, the cart 100 may have any suitable structure for retaining the object on the cart 100.

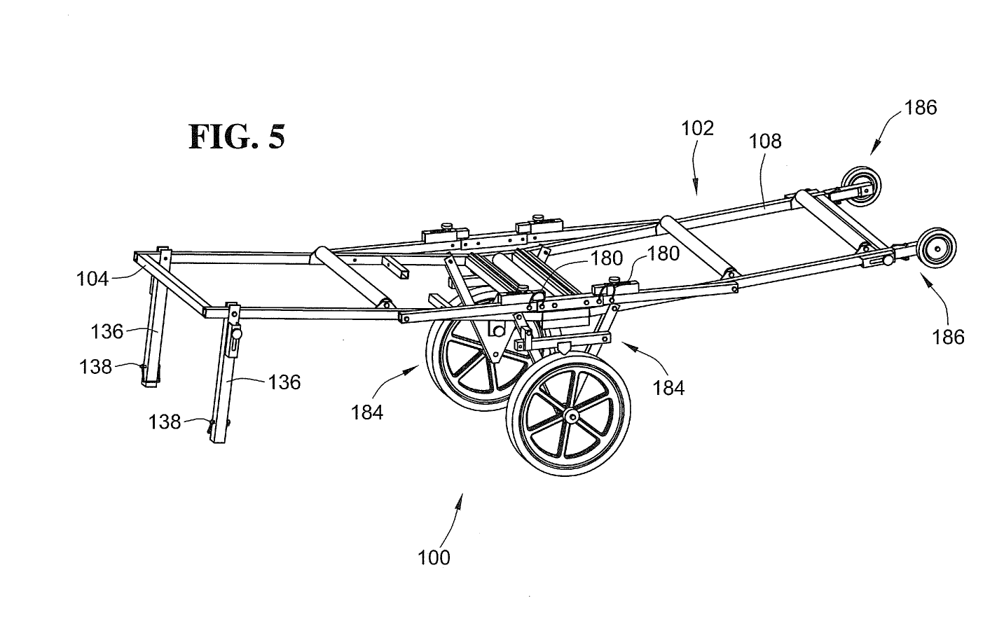

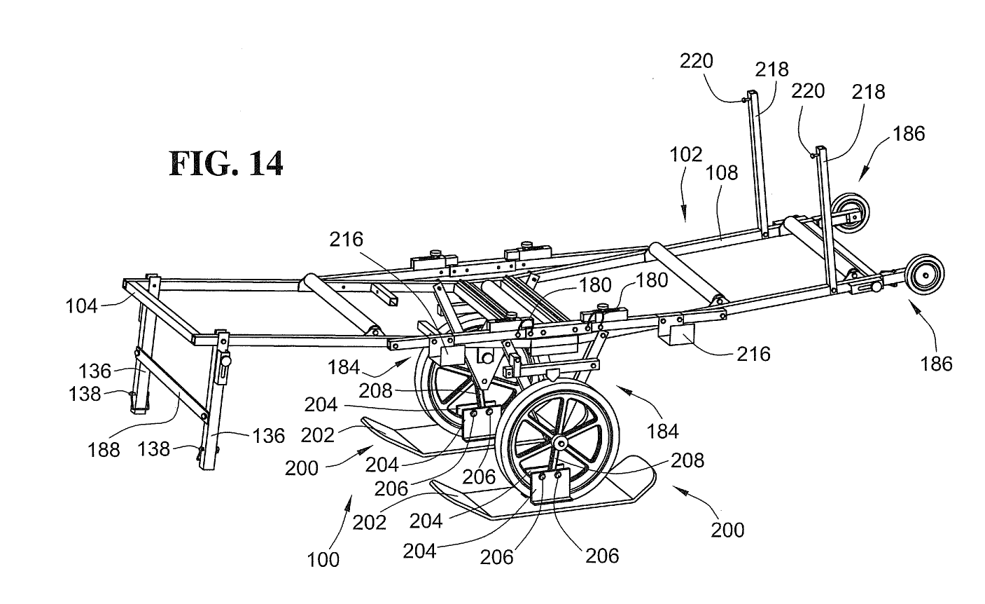

As shown in FIG. 5, the cart 100 may further have a support structure that enables the rear handle portion 104 to rest in a substantially horizontal orientation. This permits the cart 100 to remain in a relatively stable position to allow a user to tighten the retaining straps 132 (such as shown in FIG. 4) and/or allow the cart 100 to otherwise remain in a stationary position without the object sliding off of the cart 100. This may additionally be beneficial when the operator wants to leave the cart 100 in a stationary position for a period of time. The cart 100 may have one or more support legs 136 that are preferably pivotably coupled to the rear handle portion 104 of the frame 102. To minimize the amount of space required by the support legs 136 when not in use and/or when the cart 100 is in the closed position (as will be explained in greater detail below), the support legs 136 may comprise a u-shaped channel such that they fit over the respective portions of the frame 102 (when not in use) to which they are coupled (see FIG. 1). The support legs 136 may be retained against rear handle portion 104 using any suitable retaining structure including, but not limited to, a retaining pin 138. The retaining pins 138 may be removed and the support legs 136 may be pivoted downward from the rear handle portion 104 to provide support for the cart 100 near the rear end of the rear handle portion 104 so long as the combined center of gravity of the supported object and the elements of the cart supported on the wheels 112 is disposed either over the wheels 112 or between the wheels 112 and the rear handle portion 104. In some embodiments, such as shown in FIG. 14, the support legs 136 may be coupled to one another by a crossbar 188 such that the support legs 136 move together rather than independently. The support legs 136 in combination with the main wheels 112 permit the cart 100 to rest in a stable substantially horizontal orientation.

In order to further stabilize the cart 100, the main wheels 112 may have a braking mechanism 140 that maintains the main wheels 112 in a stationary position when the braking mechanism 140 is engaged. The braking mechanism 140 is desirable, for example, when the cart 100 is disposed on an uneven surface to prevent the cart 100 from moving. The braking mechanism 140 also resists movement of the cart 100 when loading an object onto the cart 100, maneuvering the object into a position for securing, and securing the object the cart 100.

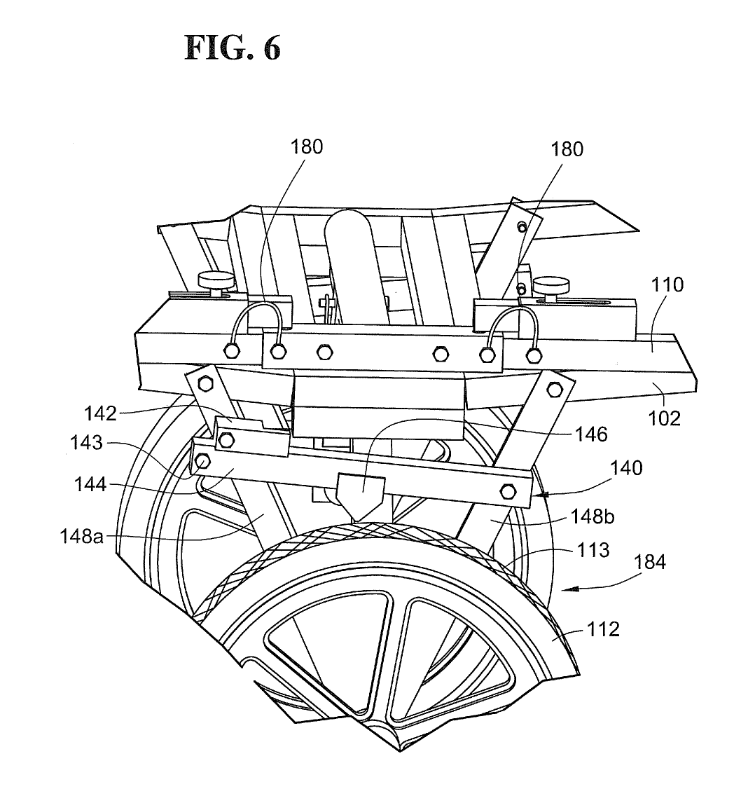

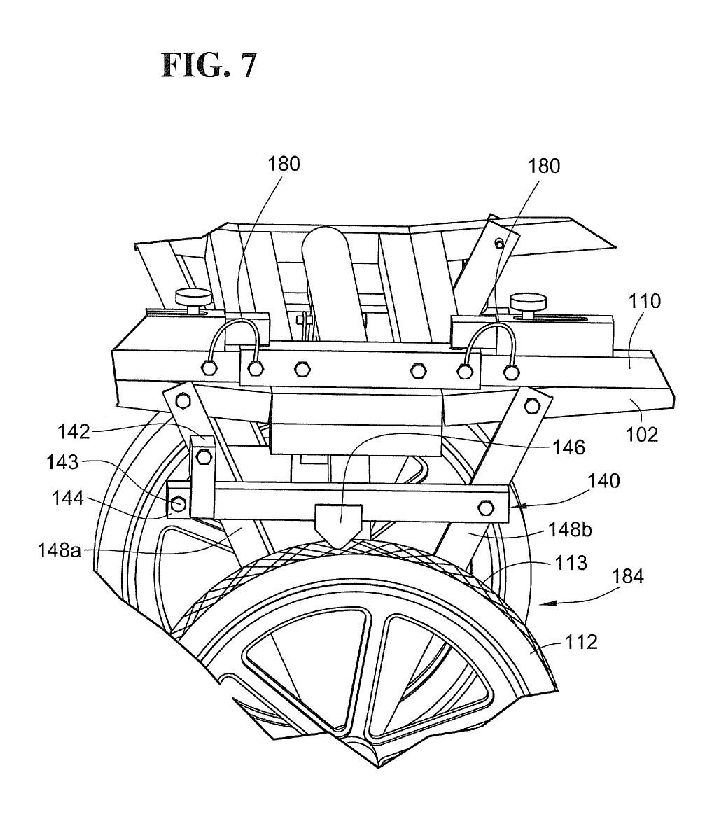

While the braking mechanism 140 may include any appropriate design, in the embodiment shown in greater detail in FIGS. 6 and 7, the braking mechanism 140 includes an actuation portion, here, a lever 142 and a crossbar 144, and an engagement portion 146, here, an engagement portion 146 of a substantially triangular configuration. The lever 142 is pivotably coupled to one of the respective support members 148a of the main wheels 112. When the lever 142 is pivoted downward as in FIG. 7, it pivots the crossbar 144, which is pivotably coupled to the other support member 148b of the respective main wheel 112. As the crossbar 144 moves downward, the triangular portion 146 engages the treads 113 of the main wheels 112 to resist movement of the wheels 112 relative to the triangular portion 146 of the brake 140, The crossbar 144 may comprise a structure, such as bolt 143, to act as a stop for the lever 142 when the lever 142 is pivoted downward. The crossbar 144 may also comprise a biasing mechanism (not shown) to bias the crossbar 144 in a disengaged position to resist unintentional engagement of the braking mechanism 140. Any suitable biasing mechanism may be used. It will be appreciated that any suitable braking mechanism 140 may be utilized such that the wheels 112 may be locked in a stationary position.

In order to transport the cart 100 from one location to another, the cart 100 may be pushed or pulled by the operator. For example, the operator may use the rear handle portion 104 of the frame 102 to apply a force on the cart 100. Alternately, a hitch 150, such as the hitch in FIG. 4, may optionally be coupled to the cart 100 to allow the cart 100 to be pulled by a vehicle, such as an all-terrain vehicle (ATV). The ability to connect the cart 100 to a vehicle is particularly useful when transporting an object over large distances. The hitch 150 may be any suitable shape or size such that the cart 100 may be secured to a vehicle for pulling the cart 100. Furthermore, the hitch 150 may be attached to the cart 100 in any suitable manner, including being removably attachable or fixed to the cart 100.

Typically, carts 100 must be lifted in their entirety to place them in a vehicle (the flatbed of a truck, for example). Given that the cart 100 is often used for transporting heavy objects, an individual will often not be able to lift the loaded cart 100 and even with assistance, the loading of the cart 100 into a vehicle can be a challenge due to the height 100 that the cart and object must be raised. The cart 100, thus, has one or more features that facilitate rather simple loading of the cart 100 onto a vehicle by an individual. In accordance with teachings of the invention, the cart 100 may have one or more forward wheel assemblies 186 having forward wheels 134 disposed near the forward end of the cart 100. As shown, the forward wheel assemblies 186 may comprise forward wheels 134 that may be coupled to a forward wheel support 152 having a unshaped channeled structure that fits over the posts 154 extending from the end of the forward support portions. The wheel support 152 may be secured to the frame 102 using a retaining pin 156 or any other suitable structure.

The forward wheels 134 may be smaller than the main wheels 112 and may have any suitable outer diameter. In some embodiments, the outer diameter of the forward wheels 134 may be approximately greater than or equal to four inches and approximately less than or equal to eight inches. In some embodiments, the outer diameter of the forward wheels 134 may be approximately 5.75 inches.

By way of example and not limitation, in order to load the cart 100 onto the flatbed of a truck, an operator may push the cart 100 with the forward support portion 108 pivoted upward a sufficient height such that the forward wheels 134 are disposed on or just above the bed of the truck. The operator may then lift the rear handle portion 104 (thus, lifting the cart 100) and push the cart 100 forward until the main wheels 112 are disposed on the truck bed. The burden of lifting the cart 100 is significantly reduced for the operator because when the forward wheels 134 of the cart 100 are on the truck bed, the truck will support a substantial portion of the weight of the cart 100 and the object disposed thereon. In this way, a single operator may load the cart 100 onto the truck bed.

It will be appreciated that the forward wheels 134 and the axle of the forward wheels 134 is preferably spaced sufficiently close to the forward end of the frame 102 to facilitate loading the cart 100 onto a trailer, or into a truck or other vehicle, yet sufficiently spaced from the forward end to provide support to a carcass or other supported object while minimizing any moment about the forward wheels 134 created by the load. In some embodiments, the axle of the forward wheel 134 may be approximately greater than or equal to 3.5 inches and approximately less than or equal to 6.5 inches away from the frame 102 near the forward end of the frame 102. Furthermore, in some embodiments, the axle of the forward wheel 134 may be approximately 4.5 inches away from the frame 102 near the forward end of the frame 102.

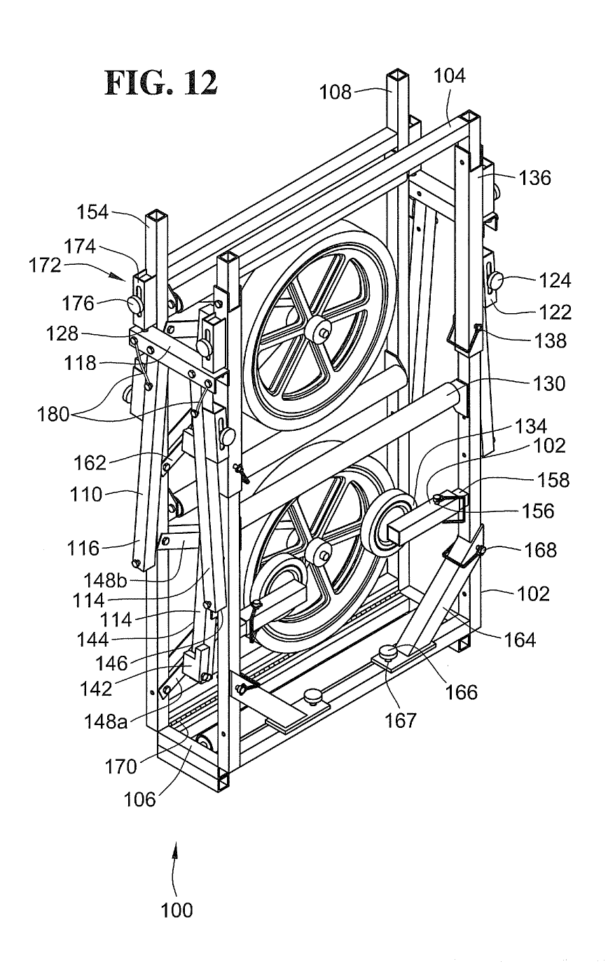

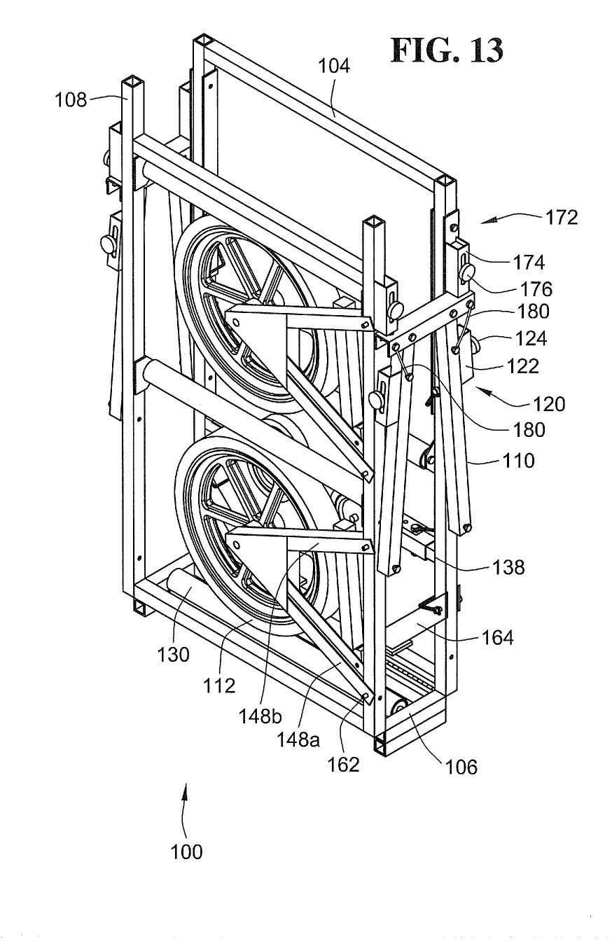

In addition to being relatively easy to transport when carrying an object, the cart 100 is also easy to store and transport when not being used to carry an object. As shown in FIGS. 12 and 13, the cart 100 has a structure that permits the cart 100 to be folded into and unfolded from a closed configuration such that the cart 100 in the closed configuration may be easily carried and stored in a relatively compact space. The cart may have one or more straps suitable to fit over an operator's shoulders for carrying the cart 100 in a closed configuration (not shown in the illustrated embodiments, but as will be understood by those of skill in the art).

Further, the closed configuration provides features that accommodate component parts of the cart 100 to be attached to the frame 102 such that the component parts do not take up excess space outside the dimensions of the closed frame 102. For example, the frame 102 may have structure for coupling the forward wheels 134 and the main wheels 112 to the frame 102 in an “internal” position. These features will be explained in more detail below.

The following example further illustrates the invention but, of course, should not be construed as in any way limiting its scope. As shown, the posts 156 extend inward from respective sides of the rear handle portion 104 of the frame 102. To fold the cart 100 into the closed configuration, the forward wheels 134 may be detached from the forward support portion 108 of the frame 102 by removing securing pins 158 that retain the forward wheels 134 to the frame 102. Each of the u-shaped channel portions of the forward wheel supports 152 may fit over a respective post 158. The forward wheels 134 may be secured to the posts 154 using the same pins 158 that secure the forward wheels 134 to the forward support portion 108.

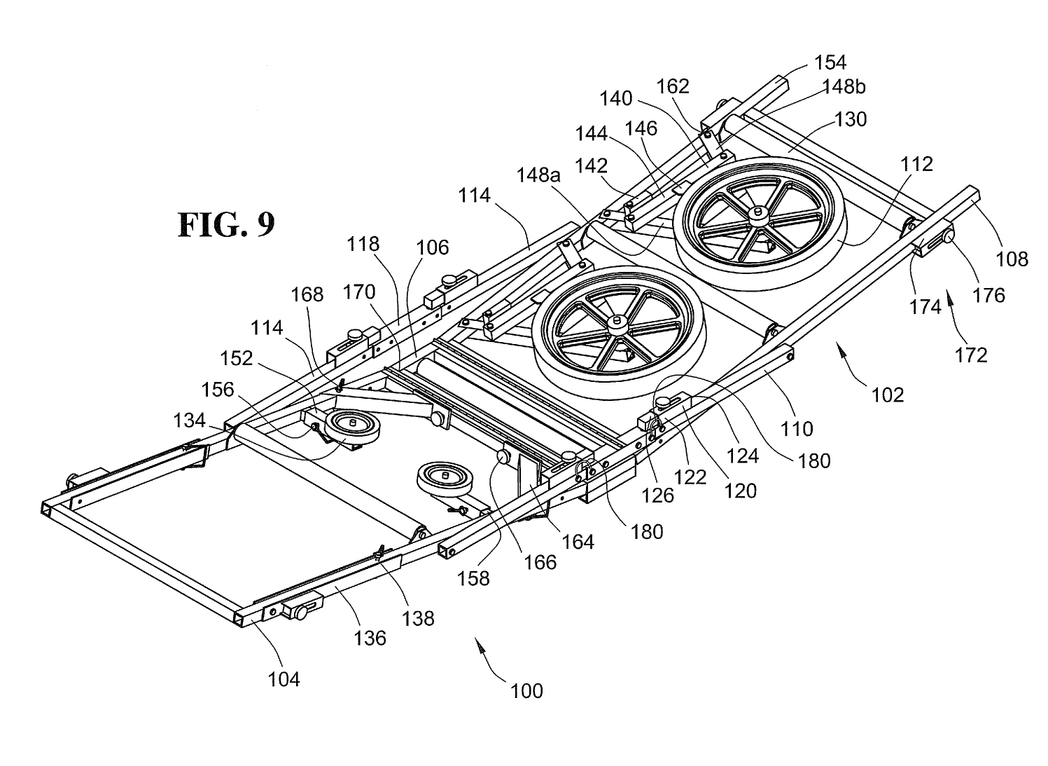

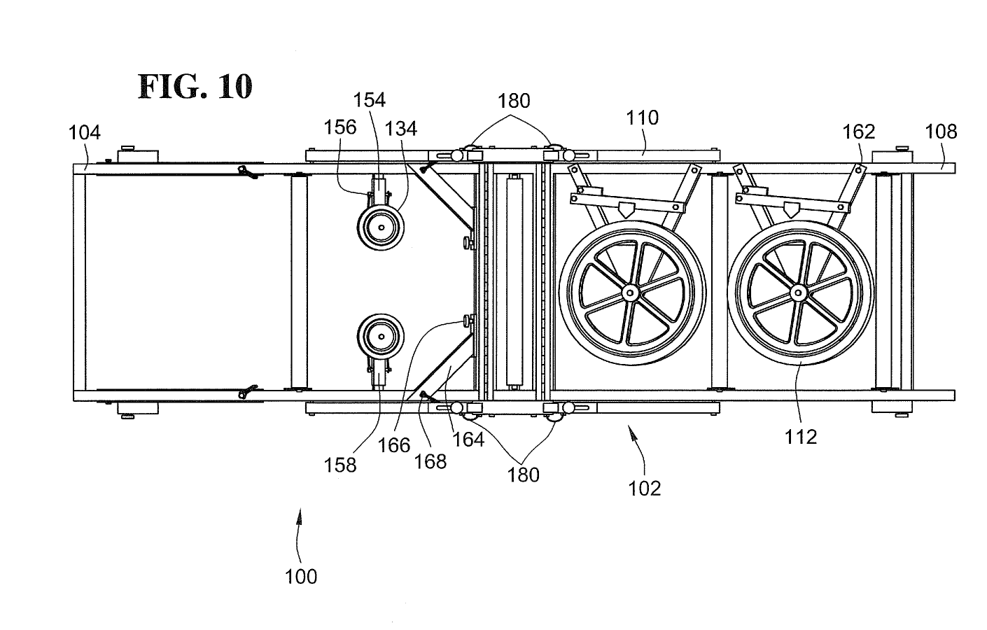

The main wheels 112 may also be detached from the frame 102 in a similar manner as the forward wheels 134. As mentioned above and shown in FIG. 8, each main wheel 112 is attached to the frame 102 via an A-frame support structure and a detachable angled support bar 164, wherein each support member 148a, 148b of the A-frame support structure is coupled to the frame 102 by a retaining pin 162. To remove the main wheels 112, the retaining pins 162 are removed from the A-frame. The angled support bar 164 is removed from the A-frame by unscrewing a knob 166 and detached from the frame 102 by removing a retaining pin 168 attached to the center transition portion 106. Turning to FIGS. 9 and 10, once detached, each of the main wheels 112 can be attached to the frame 102 (e.g., the forward support portion 108) such that the wheels 112 are disposed substantially within the dimensions of the frame 102. To this end, the support members 148a, 148b of the A-frame support structure may be coupled to the frame by inserting the retaining pins 162 into the apertures 160 on the frame 102. Similarly, the angled support bar 164 is attached to the frame 102, as shown, by screwing the knob 166 into an aperture in the frame 102 and using the retaining pin 168 to attach to another aperture in the frame 102. In this embodiment, the forward wheels 134, main wheels 112, and angled support bar 164 may be coupled to the frame 102 in the closed configuration at the respective locations described above. It will be appreciated, however, that one or more of these components may be disposed at alternate locations in the closed configuration such that the cart may be easily stored and/or transported.

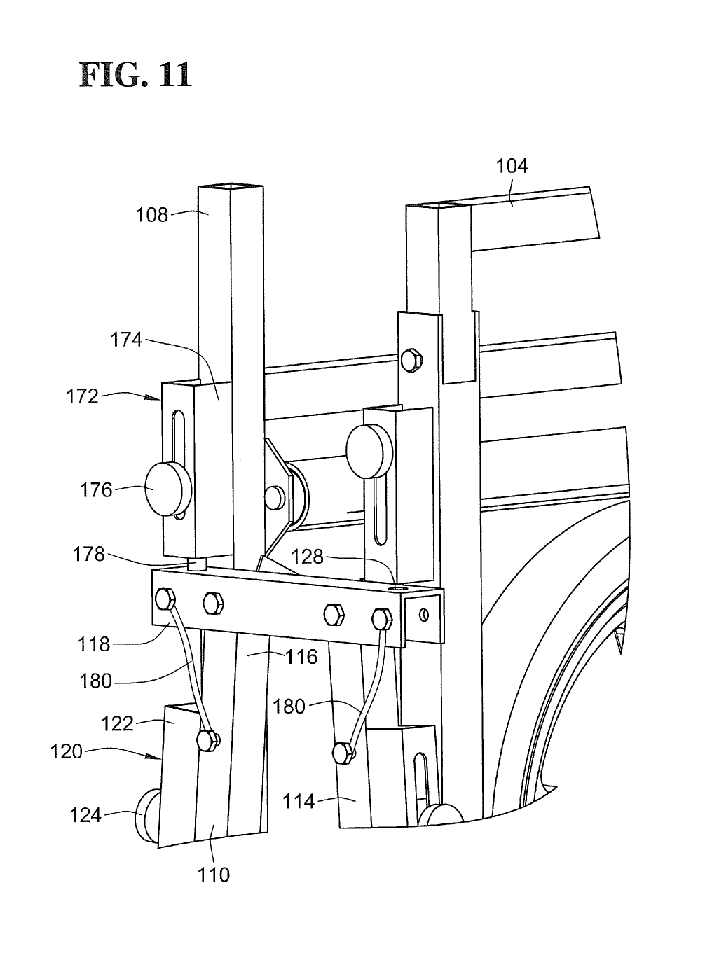

The support braces 110, as explained above, are retained in a co-linear arrangement by one or more locking mechanisms 120. The locking mechanisms 120 may be disengaged by sliding the knobs 124 to retract the respective bars 126 into the respective housings 122. The frame 102 may now be converted into the closed configuration. Each of the rear and forward support brace members 114, 116 are pivotal relative to the frame 102 and the respective intermediate members 118. These components may be pivoted relative to one another as the rear handle portion 104 and the forward support portion 108 of the frame 102 are pivoted around the center transition portion 106 of the frame 102 in a direction toward one another. The rear handle portion 104 and the forward support portion 108 are pivotable relative to the center transition portion 106 via one or more hinges 170 (such as piano hinges). The rear handle portion 104 and the forward support portion 108 are pivoted until each is at an angle substantially perpendicular to the center transition portion 106. The cart 100 may have one or more features suitable to prevent over-folding of each side of the cart 100. For example, one or more cables 180, as shown in FIG. 9, may be disposed on the support braces 110. Each cable 180 may be connected between the intermediate member 118 and one of the rear or forward support brace members 114, 116. As shown in FIGS. 11-13, the cables 180 become taut as the rear handle portion 104 and the forward support portion 108 are folded toward one another to resist overextension of the rear handle portion 104 and the forward support portion 108.

To retain the cart 100 in the closed configuration, as shown in FIG. 11, the cart 100 has a locking structure 172 comprising one or more locking pins 178 that may be slidably maneuvered with a knob 176 out of a locking housing 174 into apertures 128 in the center transition portion 106. Optionally, one or more straps (not shown) may be attached to the cart 100 such that the cart may be carried by an operator (on an operator's back similar to a backpack, for example).

To open the cart 100 into the open transportation configuration, the locking pins 178 are disengaged such that the forward support portion 108 and the rear handle portion 104 of the frame 102 may be pivoted away from one another. As the frame 102 is opened, the rear and forward support brace members 114, 116 are pivoted relative to the intermediate member 118 until the forward support brace member 116, the rear support brace member 114, and the intermediate member 118 are co-linear relative to one another. The locking mechanisms 120 may be extended out of the locking housings 122 using the knobs 124 to lock the forward support brace member 116, the rear support brace member 114, and the intermediate member 118 in the co-linear orientation. The retaining pins 162 securing the main wheels 112 to the frame 102 may be removed so that the main wheels 112 may be placed and secured with said retaining pins 162 below the center transition portion 106 of the frame 102. The angled support bar 164 may be removed from the storage position by unscrewing the knob 166 and removing the retaining pin 168. The angled support bar 164 may then be attached to the A-frame structure of the main wheel 112 by screwing the knob 166 and attached to the center transition portion 106 by inserting the retaining pin 168 through an aperture in the angled support bar 164 and an aperture in the center transition portion 106.

The forward wheels 134 may be detached from the posts 158 by removing respective retaining pins 156. Said retaining pins 156 may then be utilized to secure the forward wheels 134 to the forward support portion 108 of the frame 102 when the unshaped channel is disposed over respective posts of the forward support portion 108 of the frame 102.

It will be appreciated that components described above as being removably attached by retaining pins and/or knobs may be removably attached by any suitable structure. It will also be appreciated that like shown features in the drawings may represent the same or similar feature shown in the other drawings regardless of whether a reference number is assigned for that feature in a given drawing or whether that feature is described with respect to a given embodiment.

In some embodiments, the main wheels 112 and/or the forward wheels 134 may rest on or be replaced with alternative movement structures. Turning to FIG. 14, by way of example and not limitation, the main wheel assemblies 184 and/or the forward wheel assemblies 186 may be mounted such that they rest on one or more ski assemblies 200 comprising one or more skis 202 suitable for transporting the cart through snow or ice covered terrain. The ski assembly 200 may comprise any suitable structure for attachment to the cart 100. By way of example and not limitation, the ski assembly 200 may comprise brackets 204 coupled to the skis 202 in any suitable manner such that the brackets 204 form a channel therebetween. The channel may receive the wheel 112 and retain the wheel 112 with a coupling structure, such as the two bolts 206 positioned on either side of a spoke 208 of the wheel 112 in the illustrated embodiment. The brake 140 may also be engaged to resist rotation of the wheel 112.

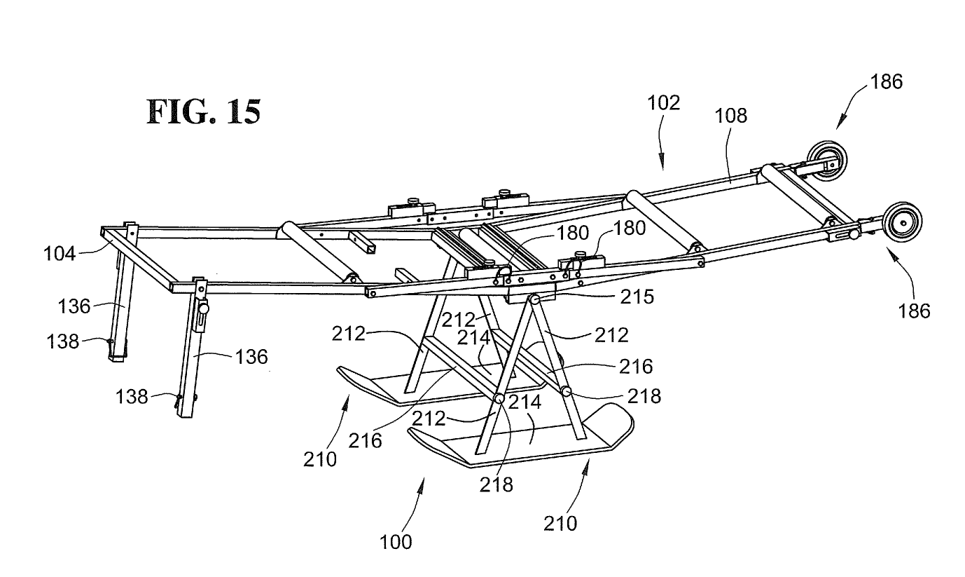

In embodiments such as shown in FIG. 15, the main wheel assemblies 184 and/or the forward wheel assemblies 186 may be replaced with one or more ski assemblies 210 comprising one or more support members 212 coupling one or more skis 214 to the frame 102. The skis 214 may be removably coupled to the frame 102 in any suitable manner. Crossbars 216 may be removably coupled to the support members 212, such as shown, to resist independent movement of each ski 214. Crossbars 216 may be removably coupled via any suitable structures such as rotatable knobs 218 which may be threaded to couple a crossbar 216 to a support member 212.

As shown, the ski assembly 210 may be attached to the frame 102 via any suitable structure such that the ski assembly 210 may be pivotably coupled to the frame and/or non-pivotably coupled to the frame. By way of example and not limitation, the ski assembly 210 may be coupled to the frame by fastener knob 215. Fastener knob 215 may be rotatable to tighten and loosen the attachment between the ski assembly 210 and the frame 102. For example, when the fastener knob 215 is fully tightened, it may prevent pivotal movement of the frame 102 such that the cart may be pushed or pulled across snow or ice covered terrain. When loading an object on or off of the cart 100, the fastener knob 215 may be loosened through rotation to allow the frame 102 to be pivoted. To remove the ski assembly 210 from the frame 102, the fastener knob 215 may be further rotated until it may be separated from the frame 102 and ski assembly 210.

The skis may be any suitable length and width. In some embodiments, the width of the skis may be approximately less than or equal to six inches such as, for example, on the order of 5.75 inches wide. In some embodiments, the skis may be approximately less than or equal to twenty-four inches long, such as, for example, on the order of 20.5 inches long.

It will also be appreciated that the cart may additionally be equipped with a first aid kit and/or a survival kit in case of emergency (not shown in the figures, but as would be appreciated by those of skill in the art). As shown in FIG. 14, it will also be appreciated that a mounting structure such as brackets 216 may be provided to mount accessories such as a gun, bow, tools, etc. to the frame 102.

Normally, the process of gutting game requires at least two individuals, one to accomplish the gutting and the other(s) to hold the legs of the game apart. According to another feature of the invention, the cart may comprise a suitable structure to permit an individual to accomplish the gutting. As shown in FIG. 14, in some embodiments one or more leg spreaders 218 may be removably coupled to the frame 102 such that a deer or other suitable game may be gutted by an individual. The leg spreaders 218 may comprise a structure suitable for tying respective legs of the game to the leg spreaders 218. The legs may be tied with any suitable material, such as a rope, to attachment portions of the leg spreaders 218, such as bolts 220 or other suitable structures. Any suitable number of leg spreaders may be provided. Therefore, the cart offers the convenience of allowing the game to be gutted in the field by an individual, supporting the game in an elevated position such that the game is maintained above any contaminants on the ground, permitting convenient drainage from the animal during the gutting by the elevated support of the game as well as the pivoting ability of the cart, and allowing the gutting to take place after the game is secured to the cart.

It will be appreciated that any suitable components of the cart may be removably coupled on the cart. Furthermore, any suitable components of the cart may be coupled to the cart in a suitable fashion when the cart is in the closed configuration for storage or transportation.

It will be further appreciated that although certain features may be described as “forward” or “rear” for ease of relative identification, these terms are not intended to be limiting in any way inasmuch as the cart may be pushed or pulled. Thus, any of the components of the cart may be forward or rear relative to one another depending on the direction of travel of the cart.

A cart for transporting objects, such as game, is disclosed herein. As described above, the cart is foldable between a closed storage configuration and an open transportation configuration. The cart has a structure that permits objects to be easily loaded thereon and transported therewith. Furthermore, the cart has a structure that permits the loading of the cart and object into a vehicle by a single operator.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A cart for transporting across a surface an object disposed on the cart, the cart comprising:
a frame for supporting the object, the frame including a handle portion;
at least one wheel assembly coupled to the frame for supporting the frame on said surface, the at least one wheel assembly having at least one wheel;
at least one roller rotatably coupled to the frame, the at least one roller being disposed such that when the object is placed on the frame, the object contacts the at least one roller to facilitate movement of the object relative to the frame.

2. The cart of claim 1 further comprising a retainer for securing the object on the cart.

3. The cart of claim 2 wherein the retainer comprises at least one strap coupled to the frame.

4. The cart of claim 1 wherein the cart is foldable to a storage configuration.

5. The cart of claim 4 further comprising a locking structure for locking the cart in the storage configuration.

6. The cart of claim 1 wherein the at least one wheel assembly is removably coupled to the frame.

7. The cart of claim 1 wherein the frame has a length and the at least one wheel assembly is substantially centrally disposed along the length of the frame.

8. The cart of claim 1 wherein the frame has a first end and a second end, the handle portion being disposed near the first end, and the cart further comprising at least one secondary wheel assembly having at least one secondary wheel, the at least one secondary wheel assembly being disposed near the second end.

9. The cart of claim 1 wherein the at least one roller is disposed substantially parallel to the handle portion.

10. The cart of claim 1 further comprising at least one support leg pivotably coupled to the frame.

11. The cart of claim 1 further comprising a brake mechanism coupled to the at least one wheel assembly for resisting rotation of the at least one wheel.

12. The cart of claim 1 wherein the frame comprises at least two frame portions and a hinge disposed between the at least two frame portions such that the at least two frame portions are pivotable at the hinge.

13. A cart for transporting across a surface an object disposed on the cart, the cart comprising:
a frame for supporting the object, the frame having a first end and a second end, the frame including a handle portion disposed near the first end of the frame;
at least one main wheel assembly coupled to the frame for supporting the frame on said surface, the at least one main wheel assembly having at least one main wheel with a main wheel outer diameter, the main wheel outer diameter being approximately greater than or equal to ten inches, and the main wheel outer diameter being approximately smaller than or equal to sixteen inches;
at least one second wheel assembly disposed near the second end of the frame, the at least one second wheel assembly having at least one second wheel with a second wheel outer diameter, the second wheel outer diameter being smaller than the main wheel outer diameter; and
the frame being pivotable at the main wheel with respect to the surface such that the second end of the frame and the at least one second wheel can be raised with respect to the surface by asserting a pivoting force on the handle portion.

14. The cart of claim 13 wherein the frame comprises at least two frame portions and a hinge disposed between the at least two frame portion such that the at least two frame portions are pivotable at the hinge.

15. The cart of claim 13 wherein the cart is foldable to a storage configuration.

16. The cart of claim 15 further comprising a locking structure for locking the cart in the storage configuration.

17. The cart of claim 13 wherein the frame has a length and the at least one wheel assembly is substantially centrally disposed along the length of the frame.

18. The cart of claim 13 wherein the at least one main wheel assembly is removably coupled to the frame.

19. The cart of claim 13 wherein the at least one second wheel assembly is removably coupled to the frame.

20. The cart of claim 13 further comprising a brake mechanism coupled to the at least one main wheel assembly for resisting rotation of the at least one main wheel.
